(19) United States
(12) Patent Application Publication
(10) Pub. No.: US 2025/0083253 A1
(43) Pub. Date: Mar. 13, 2025

(54) APPARATUS FOR COATING A WORKPIECE USING A LASER DEVICE

(71) Applicant: HPL TECHNOLOGIES GMBH, Aachen (DE)

(72) Inventor: Tobias Phillip UTSCH, Wetzlar (DE)

(73) Assignee: HPL TECHNOLOGIES GMBH, Aachen (DE)

(21) Appl. No.: 18/721,333

(22) PCT Filed: Dec. 22, 2022
(86) PCT No.: PCT/DE2022/100975

§ 371 Date: Jun. 18, 2024

(30) Foreign Application Priority Data
Dec. 22, 2021 (DE) 10 2021 214 891.3

(51) Int. Cl. B23K 26/34; B23K 26/04; B23K 26/14; B23K 26/144

(52) U.S. Cl. CPC B23K 26/34; B23K 26/048; B23K 26/144; B23K 26/1464

(57) ABSTRACT

The invention relates to an apparatus for coating a workpiece, having at least the following components: a laser device for generating a laser beam with a laser focus; a powder nozzle; and an advancing actuator system for advancing the laser device and the powder nozzle, wherein the laser device is designed for thermally treating powder material supplied by the powder nozzle for coating a surface of a workpiece and/or for thermally treating this surface. The apparatus also has: —a measuring device for recording coordinates of a point on a surface to be coated; and at least one adjusting device for adjusting the laser focus and the powder nozzle relative to one another. With the workpiece proposed here and the associated reference mark, high-precision application of a finishing layer to the workpiece can be carried out.

The invention relates to an apparatus for coating a workpiece, to an alignment method with such an apparatus for coating a workpiece, to a computer program with such an alignment method, and to a computer program product with such a computer program.

The invention relates to an apparatus for coating a workpiece, and to an alignment method with such an apparatus for coating a workpiece, and to a computer program and a computer program product for executing such an alignment method.

Additive manufacturing methods are increasingly of interest for large-scale manufacturing. The aim of additive coating methods is usually to equip a base body with a coating which is better suited for the respective application. This opens up the possibility of using a base body which is made of a mechanically and/or thermally more suitable material and/or can be manufactured more cost-effectively. This is known, for example, in the field of brake discs, cylinder cycles in engine blocks and pistons for external applications.

Among the additive manufacturing methods, the localized coating methods, i.e. those that feed coating material to the processing point at the right time, including laser spraying and laser deposition welding, for example extreme high-speed laser application [EHLA] as known for example from DE 10 2011 100 456 A1, are advantageous in many respects. In this case, a usually thin layer can be applied to the surface of a base body within a very short process duration, with low energy consumption, efficient use of powder material and a high bonding quality, which in turn can save material depending on the application. However, this also means that the welding tracks to be applied must be applied with a high degree of precision. In currently known manufacturing methods, this precision depends to a high degree on how skilled the worker is at operating the manufacturing machine, whereby test tracks for example are welded and manual readjustment is performed.

Proceeding from the aforementioned, the object underlying the present invention is to at least partially overcome the disadvantages known from the prior art. The features according to the invention are apparent from the independent claims, for which advantageous embodiments are shown in the dependent claims. The features of the claims can be combined in any technically expedient way, and the explanations from the following description and features from the figures, which comprise additional embodiments of the invention, can also be used for this purpose.

The invention relates to an apparatus for coating a workpiece, having at least the following components:
a laser device for generating a laser beam with a laser focus;
a powder nozzle; and
a feed actuator unit for feeding the laser device and the powder nozzle;
   wherein the laser device is designed for thermally treating powder material supplied via the powder nozzle for coating a surface of a workpiece and/or thermally treating this surface.

The apparatus is most notably characterized in that the apparatus also has:
a measuring apparatus for detecting coordinates of a point on a surface to be coated; and
at least one adjusting device for adjusting the laser focus and the powder nozzle relative to one another.

Ordinal numbers used in the above and following description, unless explicitly stated otherwise, are only used to clearly differentiate and do not reflect the order or ranking of the designated components. An ordinal number greater than one does not necessarily mean that another such component must be present.

The coating apparatus is a laser spraying machine, for thermal coating, or a laser welding machine, for example for deposition welding, preferably for the abovementioned extreme high-speed laser application [EHLA]. The coating, for example for surface finishing, is realized with a material which is provided in powder form via the powder nozzle. The powder material is fused or melted by means of the laser device and/or introduced into a melt pool formed by means of the laser device in the surface to be coated and thus bonded to the surface to be coated at an atomic level.

The laser device is fed from and/or comprises one or a plurality of laser sources. The laser beam or the plurality of laser beams of the laser device are focused on a laser focus, whereby the energy density (intensity) for the desired (maximum) thermal input is preferably only present in this area. The laser focus has a spatial extent, for example with a diameter (in a plane parallel to the surface to be coated) of from 1 mm [one millimeter] to 12 mm, for example of from 1.2 mm to 8 mm, particularly preferably of from 3 mm to 4 mm. It is pointed out that the area is dependent on the power of the laser beam used and should have an increasing diameter with increasing power for a desired energy density on the surface to be coated. In one embodiment of the application method that can be carried out with the coating apparatus, the intersection point or the intersection area between the laser focus of the laser device and the surface to be coated is formed outside the region of the highest intensity of the laser beam. This intersection point or this intersection area is effective for melting and for a weld penetration in the surface. However, in simplified terms, this intersection between the laser beam and the surface to be coated is referred to here as a laser focus.

It should be noted that in one embodiment of the alignment method, as explained in more detail below, the surface to be coated is a sacrificial surface, which in one embodiment is arranged on the workpiece with the surface to be subsequently coated, for example within the surface to be coated. Such a sacrificial surface is referred to here simply as surface to be coated. Preferably, the surface to be coated is not affected, only the optical properties are changed, for example (as a result of leveling a roughness) the reflectance is increased or a predetermined reflection pattern (for example a drop shape or puddle shape as a result of a localized melting of the surface) is created. In another embodiment, the sacrificial surface is a surface of a sacrificial workpiece, which, for example, has the sole task of serving as a reference for the alignment method. For example, an anodized aluminum piece is suitable for this, the anodized surface of which changes color by means of the energy input of the laser beam by the anodized layer being removed and the solid material exposed.

The powder nozzle has one (for example lateral) or a plurality of outlets and/or an annular gap outlet, whereby the powder material is transported by means of a gas stream (for example air or an inert carrier gas). The powder material is thus conveyed as a powder stream along a powder trajectory by means of the shape of the at least one outlet and the velocity of the gas stream. For a more complex powder nozzle or a more complex gas jet, the term powder focus should be used. The powder focus is defined, for example, in a design coaxial to the laser beam by a conical arrangement of the plurality of nozzle channels (powder ring as an imaginary ring line through a plurality of points) or by an annular nozzle (circumferential powder ring). As a result of the conical design, the coaxial powder ring tapers concentrically to form a powder focus. After passing through the powder focus, the powder gas jet diverges along the propagation direction (of the laser beam). In one embodiment, the powder focus must be aligned relative to the laser focus.

The feed actuator unit is designed for feeding the laser device (or the laser focus thereof) and the powder nozzle (or the powder focus thereof) relative to the workpiece or the surface thereof to be coated. The feed actuator unit comprises at least one actuator, preferably a plurality of actuators, for the translational and/or rotational movement of the laser device and the powder nozzle and/or the workpiece. For example in the case of a brake disc as a workpiece, the brake disc is rotated about its axis of rotation (in a tool chuck) by the feed actuator unit and the laser device and the powder nozzle are guided radially, thereby creating an (at least approximate) spiral shape of the application track. In addition, a movement axis is often provided that is aligned at a normal to the surface of the workpiece, whereby this is provided for differently sized workpieces and/or for the possibility of clamping the workpiece in the tool chuck of the coating apparatus in a collision-free manner and/or in order to be able to conveniently maintain or replace the laser device and the powder nozzle. In a preferred embodiment, the feed actuator unit (per spatial axis) can be moved only with sufficient precision for the coating process, for example in the range of a few millimeters, preferably from 0.1 mm [one tenth of a millimeter] to 1 mm.

The measuring apparatus is designed (for example tactilely or optically) for detecting a point on the surface to be coated and the position thereof relative to the machine coordinate system. In one embodiment, such a point is designed arbitrarily. In one embodiment, such a point is clearly defined and reliably recognizable by a machine by virtue of its shape (for example a characteristic elevation or depression) and/or its appearance (for example the color, the reflectance etc.). In one embodiment, such a reliably machine-recognizable point is a weld penetration which can be introduced into the surface to be coated by the laser device by means of its thermal input. The measuring apparatus or the measuring result thereof is preferably more precise in terms of the coordinates detected relative to the machine coordinate system than the feed precision of the feed actuator unit. The measuring apparatus is designed, for example, for detecting (relative) coordinates in the range below a tenth of a millimeter, for example from 0.01 μm [one hundredth of a micrometer] to 10 μm, preferably 0.05 μm to maximal 5 μm. In one embodiment, the measuring apparatus comprises a plurality of measuring units which are designed on the basis of different measuring methods to detect different things and/or to detect from additional or redundant viewing angles. For example, one or a plurality of measuring units is provided for detecting the appearance of the weld penetration, a measuring unit for detecting the depth of the weld penetration and a measuring unit for determining the coordinates of the weld penetration. For example, one or a plurality of measuring units are provided for detecting the laser focus and/or the alignment of the laser focusing lens and, if necessary, the powder focus.

In one embodiment, the coating apparatus proposed here or the powder nozzle and laser device thereof can be aligned with respect to each other by hand by means of the adjusting device, i.e. they are adjustable. By means of this adjusting device, the alignment of the powder nozzle (or the powder focus) relative to the laser focus is adjustable within the range of the (for example halved, i.e tolerance-doubled) precision of the measuring apparatus, preferably only in the plane parallel to the surface to be coated. Alternatively, a relative position along the normal to the surface to be coated and/or a relative rotation can also be aligned by means of the adjusting device.

It should be noted that the powder nozzle is preferably moved for the adjusting by the adjusting device; alternatively or additionally, the laser device and/or the laser focus (for example by aligning a laser focusing lens) is adjustable by means of the adjusting device.

The coating apparatus proposed here is adjustable in an at least machine-supported process, whereby the alignment method can be carried out as often as required, for example for each workpiece or once in a maintenance cycle. This means that the coating apparatus can be used for large-scale manufacturing and at the same time a high level of precision and reliable manufacturing quality can be ensured.

It is furthermore proposed in one advantageous embodiment of the apparatus that the adjusting device for adjusting the laser focus and the powder nozzle relative to one another is movable purely by a control device using an actuator.

In this embodiment, the adjusting device has one or a plurality of actuators, for example for in each case one spatial axis and for a translational and/or rotatory movement. In one embodiment, the adjusting device comprises at least one piezo element and the piezo element is connected in series with any actuator provided for the feed actuator unit in the corresponding spatial axis. Very fine strokes are possible by means of such a piezo element and therefore a very fine adjustment. In one embodiment, the adjusting device is formed by an electric or magnetic drive and, depending on the desired precision and/or costs, the adjusting device is integral to the corresponding drive of the feed actuator unit. The adjusting device is then preferably only formed separately at the software level, with a coordinate transformation preferably being carried out. The adjusted position is therefore the new zero position, which is accessed by a controller. In one embodiment, manual adjustment is additionally possible. In a preferred embodiment, the actuator unit of the adjusting device can be controlled sufficiently precisely so that manual readjustment is not necessary. Manual readjustment is then advantageous, for example for a limited stroke path, so that a rough preadjustment is carried out by hand and then a precise adjustment is carried out within the available stroke path. Preferably, the preadjustment is performed by the feed actuator unit, whereby the coordinates in the control device are then particularly preferably changed accordingly, i.e. a (for example digital) resetting is performed.

The coating apparatus proposed here is adjustable in an automated process, whereby the alignment method can be carried out as often as required, for example for each workpiece or once in a maintenance cycle, without manual intervention by a worker. This means that the coating apparatus for large-scale manufacture can be integrated into a highly automated production line and at the same time a high degree of precision and reliable manufacturing quality can be ensured (preferably purely by machine).

According to a further aspect, an alignment method for coating a workpiece is proposed, wherein the alignment method is carried out with an apparatus according to an embodiment as described above and furthermore a control device is provided for the apparatus, wherein the alignment method is carried out by the control device and comprises at least the following steps:
a. moving, with the laser device, to a predetermined point on a sacrificial surface by means of the feed actuator unit and remaining there;
b. moving, with the powder nozzle, to the predetermined point on the sacrificial surface by means of the feed actuator unit;
c. after step a., determining the position of the laser focus relative to the point on the sacrificial surface by means of the laser device;
d. after step b. and c., displaying the relative position of the laser focus determined in step c. so that the powder nozzle can be adjusted relative to the displayed relative position of the laser focus and thus relative to the laser focus by means of the adjusting device.

In one embodiment, the alignment method proposed here can be carried out on the coating apparatus, as described hereinabove. It should be noted that the alignment method does not include executing the coating of the surface on a surface to be coated. Rather, the coating of the surface is carried out (preferably immediately) after the alignment method.

The control device is part of the coating apparatus (for example a control unit there) or an external unit, which is connected to the coating apparatus (or the control unit there) in a communicating manner.

The alignment method begins with step a., wherein a predetermined point is moved to by the laser device by means of the feed actuator unit. This point is on a workpiece that comprises the surface to be coated and is, for example, within this surface to be coated, or on a sacrificial workpiece which is not supplied to a production result of a (subsequent) coating method. The predetermined point preferably lies outside of the surface to be coated. The sacrificial surface is thus a surface that is separate from the surface to be coated. Alternatively, it is accepted that a surface property at this predetermined point is changed, for example impaired, as a result of the weld penetration, or even that no more coating can be applied at this point.

The laser device is now positioned at the predetermined point (at least after the current adjustment) and remains there. In the subsequent step c., the actual relative position of the laser focus relative to the base body is detected at the predetermined point by means of the laser device by generating a weld penetration in the sacrificial surface and/or by means of a caustic measurement, while the laser device has moved to the predetermined point. It should be noted at this point as a preliminary remark that the actually detected laser focus (determined by means of caustic measurement and/or weld penetration) and the predetermined point can diverge if a current adjustment of the laser device relative to the machine coordinate system (the control device) diverges. This is explained in more detail below and various possible solutions are mentioned. The predetermined point is therefore moved to at least according to the machine coordinate system.

Parallel to, before or after step a., in step b. the powder nozzle is aligned to the predetermined point which is to be or has been moved to by the laser device. In one advantageous embodiment, the laser device and the powder nozzle are always moved jointly together by means of the feed actuator unit, preferably without the possibility of a relative movement by means of the feed actuator unit. Such a relative movement is then only possible by means of the adjusting device. In an alternative embodiment, the weld penetration according to step c. is also possible before step b. is carried out.

In the final step d., the weld penetration formed in the sacrificial surface or the relative position of the laser focus is detected via the caustic measurement by means of the measuring apparatus and its coordinates are recorded in the control device. Meanwhile, the laser device remains at the point moved to in step a. In one embodiment, the powder nozzle is aligned relative to this detected laser focus on the basis of (sufficiently) exactly known machine-internal coordinate data. This is advantageous when the laser focus forms the basis for the machine coordinate system (see below). In another embodiment, the powder nozzle is started (preferably without welding operation), i.e. a powder stream is discharged and the position of the powder nozzle (or the powder focus) is detected by means of the measuring apparatus and its coordinates are recorded in the control device.

The powder nozzle (or its powder focus) is then adjusted relative to the laser focus by means of the adjusting device, i.e. the powder nozzle is aligned relative to the laser focus. For a particularly simple embodiment of the alignment method, an embodiment of the coating apparatus in which the powder nozzle and the laser device can only be moved relative to the sacrificial surface by means of a common feed actuator is particularly advantageous. The adjusting device is then connected in series to the feed actuator unit in relation to the laser device and the powder nozzle or is designed with a spatial axis as the adjustment direction that deviates from the at least one feed direction of the feed actuator unit.

It is further proposed in an advantageous embodiment of the alignment method that in a step e. after step c. and before step d., the laser focus is adjusted
by comparing, in a sub-step e.1 for determining a deviation by means of the measuring apparatus, the coordinates of the predetermined point with the coordinates of the relative position of the laser focus determined in step c., and preferably displayed in step d., and
by adjusting, in a sub-step e.2 according to the deviation established in sub-step e.1, the laser focus relative to a fixed machine coordinate system of the apparatus by means of the feed actuator unit and/or by means of the adjusting device.

In this embodiment, it is taken into account that there may also be a deviation between the predetermined point and the detected laser focus (for example weld penetration or the result of the caustic measurement) due to a (faulty) current adjustment of the laser focus to the machine coordinate system. In the step e., this is balanced out in the sub-step e.2, whereby this is carried out analogously to the above description with regard to the powder nozzle or the powder focus. Preferably, only a single weld penetration is formed or a single caustic measurement is carried out by aligning the laser focus to the machine coordinate system by means of the feed actuator unit and/or the adjusting device on the measurement result in sub-step e.1.

In an advantageous embodiment, at least one second weld penetration is produced or a second caustic measurement is carried out after the laser focus has been adjusted, whereby particularly preferably (if necessary beforehand) the feed has been corrected accordingly by means of the feed actuator unit. In the latter case, the (as yet unadjusted) first and the at least one (adjusted) second detected laser focus overlap (i.e. weld penetration or the result of the caustic measurement). The adjusting unit for the laser focus and the adjusting unit for the powder nozzle (or the powder focus), if present, are connected to one another in parallel or in series, for example physically acting directly on each other or widely spaced apart. For example, the adjusting unit for the laser focus is arranged on the machine bed-side of the feed actuator unit, i.e. connected upstream of it, or connected in parallel to it.

It is furthermore proposed in one advantageous embodiment of the alignment method that the coating apparatus furthermore comprises:
a memory unit for storing detected coordinates relative to actuator coordinates; and
at least one processor for executing memory operations and calculations with coordinates stored on the memory unit, wherein in a step e. after step c., the laser focus is adjusted by comparing, in a sub-step e.1 for determining a deviation by means of the measuring apparatus, the coordinates of the predetermined point with the coordinates of the relative position of the laser focus determined in step c., and preferably displayed in step d., and
   by changing, in a sub-step e.3 according to the deviation determined in sub-step e.1, the coordinates stored for the predetermined point in the memory unit.

The memory unit and the processor are preferably components of the coating apparatus, as is described previously. In one embodiment, the memory unit and/or the processor are components of the control device. The memory unit and/or the processor are for example conventional components. The actuator coordinates are the coordinates which are used for feeding (and optionally for a rough alignment), i.e. for controlling, the feed actuator unit. These are referenced to the machine coordinate system, but are subject to tolerances and operationally variable deviations and must therefore be checked.

With reference to the result in the aforementioned embodiment for adjusting the laser focus and the sub-step e.1 is identical without exclusion of generality, so that reference is made in this respect to the description there. In step e.3, however, the weld penetration is taken as a static reference and the machine coordinate system is then readjusted. In one embodiment, both the sub-step e.2 and also the sub-step e.3 are carried out, for example with staggered precision, wherein the laser focus is preferably realigned in line with the precision of the feed actuator unit in accordance with the deviation detected in sub-step e.1 and then adjusted by means of the adaptation of the machine coordinate system.

It is furthermore proposed in an advantageous embodiment of the alignment method that in step c., a weld penetration is produced in the sacrificial surface and in step d., the weld penetration is visible as an indication of the relative position of the laser focus.

In this embodiment, the relative position of the laser focus can be determined in a particularly simple way by producing a weld penetration in the sacrificial surface (also see the explanations given above). The weld penetration is preferably produced outside of a surface to be coated. Alternatively or additionally, a weld penetration is a component of a marking, for example labeling of the sacrificial surface. It should be noted that the sacrificial surface is preferably arranged in the plane of the surface to be coated, for example as part of a continuous surface of the base body, preferably in an edge region. However, a sacrificial surface can also be used, which is aligned at an angle to the surface to be coated.

In one embodiment, the weld penetration is clearly readily visible to the human eye. In another embodiment, the weld penetration can only be read (at all or reliably) by means of a measuring apparatus. In one embodiment, the shape of the weld penetration corresponds to the shape of the laser beam in this intersection area where it impacts the sacrificial surface. The shape of the weld penetration is dependent on the energy distribution, which is in turn dependent on the laser source and/or laser optics used, as well as the amount of energy used to produce the weld penetration.

It is furthermore proposed in one advantageous embodiment of the alignment method that in step c., a caustic measurement is carried out to determine the relative position of the laser focus, wherein preferably in step d., the relative position of the laser focus is visible by means of a optical projection on the sacrificial surface.

In this embodiment, the relative position of the laser focus can be determined particularly precisely, while at the same time no weld penetration is produced in the sacrificial surface (see also the explanations given above in this regard).

In one embodiment, in addition or as an alternative to the caustic measuring, a laser, preferably a so-called pointer laser (beam) (with a visible wavelength and low intensity) is used to generate a reflection pattern (mirror image) on the sacrificial surface, which is clearly readily visible to the human eye, and preferably remains visible even if the powder focus is generated by means of a powder stream and its position relative to the displayed reflection pattern is to be aligned (adjusted). The pointer laser is preferably coupled into at least one fiber of the line of the (power) laser for the (power) laser beam of the laser device and thus passes through the same optics. The optical display is thus sufficiently reliable.

In another embodiment, the reflection pattern can only be read (at all or reliably) by means of a measuring apparatus. In one embodiment, the shape of the reflection pattern corresponds to the shape of the laser beam in this intersection area where it impacts the sacrificial surface. The shape of the laser beam is dependent on the energy distribution, which is in turn dependent on the laser source and/or laser optics used, as well as the amount of energy used to produce the reflection pattern.

It is furthermore proposed in one advantageous embodiment of the alignment method that a diameter of the weld penetration in the sacrificial surface is detected by means of the measuring apparatus in a step f., wherein, depending on the diameter of the weld penetration detected in step f., a distance between the laser device and the sacrificial surface is set in a step g. by means of the feed actuator unit and/or the adjusting device.

In this additional step f., which is also carried out independently of the other method steps, but preferably after step a., particularly preferably together with step c., a relative height of the laser focus to the sacrificial surface is set in step g. This exploits the fact that, due to a diameter that varies in a known manner in the plane parallel to the sacrificial surface, a different diameter of a weld penetration results when the distance between the laser focus and the sacrificial surface changes in the normal direction (to the sacrificial surface).

In one advantageous embodiment, the distance is adjusted starting from the widest distance in the assumed tolerance and the weld penetration or the creation of a reflection pattern is repeated continuously or in steps until a target variable is reached. In another embodiment, a plurality of predetermined points are moved towards until a weld penetration or a reflection pattern with a diameter within the tolerance is reached. In yet another alternative embodiment, the weld penetration or a reflection pattern is produced at the same location, whereby the new (possibly smaller) diameter can be detected due to a clear change in the diameter (of the weld penetration or the reflection pattern). In a combination with the adjustment of the laser focus, the distance is adjusted at the same time, whereby a new weld penetration or a new reflection pattern is generated at a newly (or more precisely) moved to point with a distance that has been changed according to a deviation and therefore a new diameter in the sacrificial surface.

The adjusting unit for adjusting the height of the laser focus is, for example, a separate unit and/or arranged at the laser focusing lens.

According to a further aspect, a computer program is proposed, comprising
a computer program code, wherein the computer program code is executable on at least one computer in such a way that the at least one computer is caused to carry out the alignment method according to an embodiment according to the above description, wherein at least one unit of the computer:
   is arranged in the coating apparatus;
   is designed for communication with an edge device, on which preferably at least a part of the computer program code is provided; and/or
   is designed for communication with a cloud, on which preferably at least a part of the computer program code is provided.

The alignment method described here is computer-implemented according to this embodiment. The computer-implemented alignment method is stored as a computer program code, wherein the computer program code, when it is executed on a computer, for example comprising a memory unit and a processor, causes the computer to carry out the alignment method according to a embodiment according to the preceding description.

The computer-implemented alignment method is implemented, for example, by a computer program, wherein the computer program comprises the computer program code, wherein the computer program code, when it is executed on a computer, causes the computer to carry out the alignment method according to an embodiment according to the preceding description. Computer program code is synonymously referred to as one or a plurality of instructions or commands which cause a computer to perform a series of operations which represent, for example, an algorithm and/or other processing methods.

The computer program is executable preferably partially or in full on a server or a server unit of a cloud system, a handheld device (for example a smartphone) and/or on at least one unit of the computer. The term server or server unit is used here to refer to such a computer that provides data and/or operative services or services for one or a plurality of other computer-supported devices or computers and thus forms the cloud system. For example, a unit of the computer is arranged as an integrated control device, as a so-called edge device in the vicinity of a machine tool and/or designed for communication with a cloud, whereby at least one part of computer program code is preferably provided on the cloud.

The terms cloud system or computer are used here synonymously with the devices known from the prior art. Accordingly, a computer comprises one or a plurality of all-purpose processors (CPU) or microprocessors, RISC processors, GPUs and/or DSPs. The computer has, for example, additional elements such as memory interfaces or communication interfaces. Optionally or additionally, the terms refer to such a device which is able to execute a provided or integrated program, preferably with standardized programming language (for example C++, JavaScript or Python) and/or to control and/or access data memories and/or other devices such as input interfaces and output interfaces.

The term computer also refers to a plurality of processors or a plurality of (sub-) computers, which are interconnected and/or connected and/or connected in some other way so as to communicate and may jointly use one or a plurality of other resources, such as a memory. A (data) memory is for example a hard disk drive (HDD) or a (non-volatile) solid-state drive, for example a ROM storage device or flash storage device [Flash-EEPROM]. The storage device often comprises multiple individual physical units or is distributed over a multiplicity of separate devices, so that access thereto takes place via data communication, for example a package data service. The latter is a decentralized solution, wherein storage devices and processors of a plurality of separate computers are used instead of one (single) central server or in addition to a central server.

According to a further aspect, a computer program product is proposed, on which
a computer program code is stored, wherein the computer program code is executable on at least one computer in such a way that the at least one computer is caused to carry out the alignment method according to one embodiment according to the above description, wherein at least one unit of the computer:
   is arranged in the coating apparatus;
   is designed for communication with an edge device, on which preferably at least a part of the computer program code is provided; and/or
   is designed for communication with a cloud, on which preferably at least a part of the computer program code is provided.

A computer program product having the above-described computer program code is, for example, a medium such as for example RAM, ROM, an SD card, a memory card, a flash memory card or a disk, or is stored on a server and can be downloaded. As soon as the computer program has been made readable via a read-out unit, for example a drive and/or a software installation, the computer program code included therein and the alignment method included therein is executable by a computer or in communication with a plurality of server units, for example as described above.

The above-described invention is explained in detail hereinbelow in light of the relevant technical background, with reference to the associated drawings, which show preferred embodiments. The invention is in no way restricted by the purely schematic drawings, and it should be noted that the drawings are not to scale and are not suitable for defining proportions. In the drawings is shown:

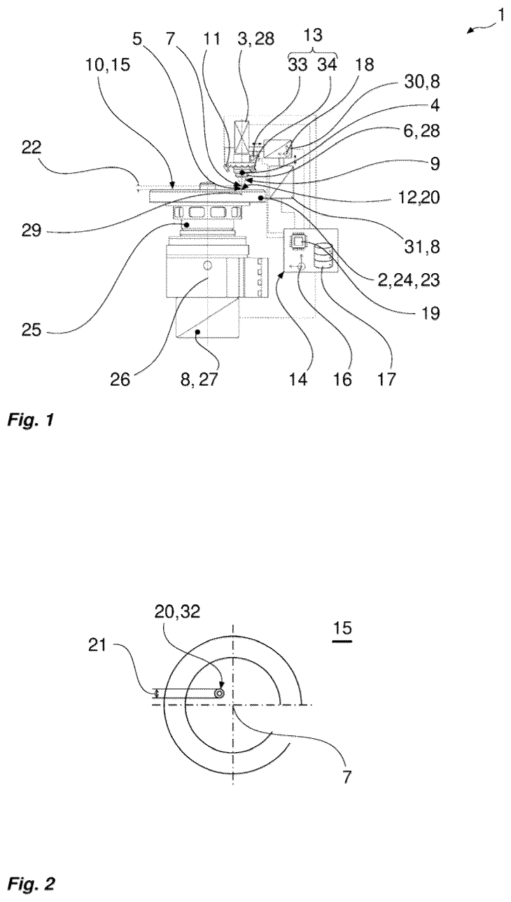

FIG. 1: a coating apparatus in a deposition welding machine with a clamped brake disc;

FIG. 2: schematically a weld penetration of a laser beam and a powder focus;

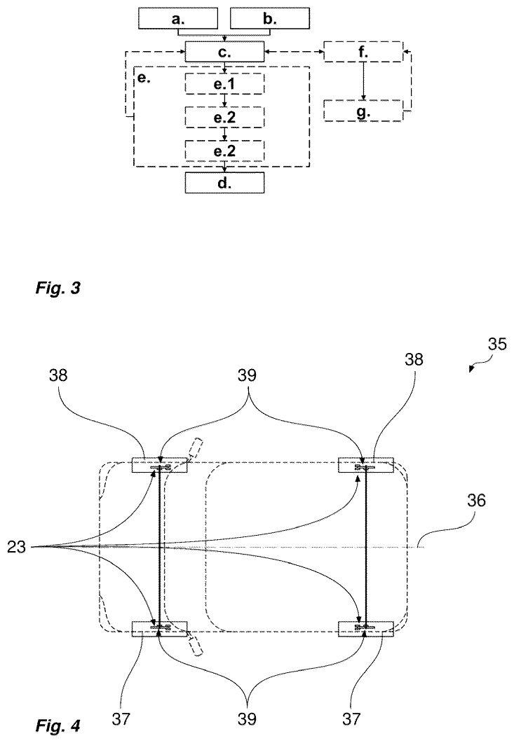

FIG. 3: a flowchart of an alignment method; and

FIG. 4: a motor vehicle with brake discs.

FIG. 1 shows, purely schematically, an apparatus 1 for coating in a deposition welding machine with a clamped brake disc 23. The brake disc 23 is here the workpiece 2 to be coated by means of the coating apparatus 1. For this, the brake disc 23 has a surface 10 (top in the illustration) to be coated and optionally an opposite rear side (bottom in the illustration). In the state shown, a layer is appliable to the surface 10 to be coated for coating the surface 10 of a base body 24. For this purpose, the brake disc 23 is clamped in the tool chuck 25 of the apparatus 1 for coating and held precisely positioned by the latter. In this embodiment, the tool chuck 25 is, for example, a clamping chuck with a rigid axis of rotation 26 and the brake disc 23 is aligned coaxially to the axis of rotation 26. The axis of rotation 26 is thus aligned normal to the surface 10 to be coated. In the embodiment shown, the tool chuck 25 is purely optionally driven by a rotary drive 27, so that the workpiece 2 is rotatable about the axis of rotation 26. The workpiece 2 is preferably repeatedly feedable by the rotary drive 27 with coordinate accuracy in accordance with a coordinate system. In this embodiment, the rotary drive 27 is a part of the feed actuator unit 8.

As shown, a coating unit 28 of the coating apparatus 1 is positioned above the workpiece 2. The coating unit 28 comprises a laser device 3 and a powder nozzle 6 and has a coating axis 29 aligned parallel to the axis of rotation 26. The predetermined point 12 is the intersection of the coating axis 29 and the surface 10 to be coated. A deviation between the laser focus 5 (for example weld penetration 20) and the predetermined point 12 cannot be seen in this illustration (cf. FIG. 2). In this embodiment, a powder material 9 is focused by the powder nozzle 6 in the form of a cone in a powder focus 7. When the alignment is adjusted, the powder focus 7 overlaps with the laser focus 5 of the laser device 3 just above the surface to be coated 10. A deviation (this is not the distance 22 normal to the surface to be coated 10) between the surface coordinates of the laser focus 5 and the parallel coordinates of the powder focus 7 cannot be seen in this illustration (cf. FIG. 2). The laser device 3 is formed by a single-beam or a multi-beam laser beam 4 (preferably in a protective gas atmosphere). The coating unit 28 shown is designed, for example, for precise high speed coating by means of EHLA. The coating unit 28 (here purely optional itself) is movable radially relative to the workpiece 2 with respect to the axis of rotation 26 by means of the horizontal positioner 30 of the feed actuator unit 8 (infeed). In addition, the coating unit 28 (here purely optional itself) is feedable vertically (i.e. parallel to the axis of rotation 26) by means of the vertical positioner 31 of the feed actuator unit 8.

Furthermore, the coating apparatus 1 comprises a measuring apparatus 11 (shown here as a camera), which is designed to detect a weld penetration 20 in the or a reflection pattern 32 on the surface 10 to be coated (cf. FIG. 2). The measuring apparatus 11 is referenced to the machine coordinate system 16 (shown purely symbolically in the control device 14), for example via a control system of the coating apparatus 1 for the aligning and feeding of the coating unit 28. The coordinate system is shown here purely optionally as a Cartesian coordinate system with the z axis pointing upwards in the image plane, the x axis pointing to the left in the image plane and the y axis pointing out of the image plane. The data and the actuator coordinates 18 (shown here purely symbolically in the horizontal positioner 30) of the feed actuator unit 8 are processed in the control device 14 (shown here purely schematically with a processor 19 and a memory unit 17), used for the actuation and synchronized. In addition, the control device 14 together with the feed actuator unit 8 and the adjusting device 13 the alignment method according to FIG. 3 to be carried out for the problem according to the FIG. 2. For this purpose, the adjusting device 13 comprises at least the first adjusting unit 33, which is connected in series with the horizontal positioner 30 here (purely optionally). The first adjusting unit 33 acts here (indirectly) on the powder nozzle 6 in the horizontal direction in the image plane (i.e. the x-direction or the radial direction based on the axis of rotation 26 of the workpiece 2) to the laser device 3. Preferably, the first adjusting unit 33 also comprises an adjustment direction out of the image plane (i.e. in the y-direction or in direction of circulation based on the axis of rotation 26 of the workpiece 2). Purely optionally, the adjusting device 13 also comprises a second adjusting unit 34, by means of which the laser focus 5 can be aligned. This second adjusting unit 34 is shown here acting (horizontally) on the laser focusing lens (preferably also both in the x-direction and in the y-direction).

FIG. 2 schematically shows a weld penetration 20 (for example a puddle shape in the surface 10 to be coated or a reflection pattern 32 of a pointer laser beam) and a powder focus 7 in a plan view of a sacrificial surface 15. The powder focus 7 deviates from the weld penetration 20 or reflection pattern 32 diagonally to the bottom right (as shown) and is realigned accordingly so that the cross of the powder focus 7 shown is then aligned as centrally as possible to the weld penetration 20 or reflection pattern 32.

In one advantageous embodiment, the diameter 21 of the weld penetration 20 in the sacrificial surface 15 is detected and a distance 22 between the laser device 3 and the sacrificial surface 15 is thus set. Either at the same or at a different location, a further weld penetration 20 is produced until the diameter 21 characteristic of the desired distance 22 is set.

FIG. 3 shows a flow diagram of an advantageous embodiment of an alignment method. The alignment method begins with step a., whereby a predetermined point 12 is moved to by the laser device 3 by means of the feed actuator unit 8 reference is made to FIG. 1 and FIG. 2 purely for the purpose of understanding, without exclusion of generality. In the embodiment shown, (purely optionally) parallel to step a. in step b., the powder nozzle 6 is aligned with the predetermined point 12, which is to be moved to by the laser device 3. The laser device 3 and the powder nozzle 6 are now positioned (at least after the current adjustment) at the predetermined point 12 and remain there. In the subsequent step c., the position of the laser focus 5 relative to the point 12 on the sacrificial surface 15 is determined at the predetermined point 12 by means of the laser device 3, for example by generating a weld penetration 20 in the sacrificial surface 15, while the laser device 3 moves to the predetermined point 12. Alternatively or additionally, the relative position of the laser focus 5 is detected by means of a caustic measurement.

In one embodiment, the laser focus 5 is (purely optionally) adjusted in a step e. In its sub-step e.1, the position of the laser focus 5 relative to the predetermined point 12 is detected. Here, both the sub-step e.2 and the sub-step e.3 are carried out (purely optionally), for example with staggered precision, wherein the laser focus 5 is preferably realigned in line with the precision of the feed actuator unit 8 in accordance with the deviation detected in sub-step e.1 and is then adjusted by means of the adaptation of the machine coordinate system 16. This is optionally a repeated process, with step c. and step e. being repeated until the deviation between the laser focus 5 and the predetermined point 12 is sufficiently small.

In one embodiment, the step f. is (purely optionally) also provided, which is carried out together with step c. Here, a relative height of the laser focus 5 to the sacrificial surface 15 is detected and set in step g. These steps are repeated if necessary, preferably together with step c. and step e.

In the final step d., the determined relative position of the laser focus 5 and the deviation thereof are detected by means of a measuring apparatus 11 (cf. FIG. 2). Meanwhile, the laser device 3 remains at the point 12. moved to in step a. The powder nozzle 6 is then aligned with this laser focus 5, for example visibly or measurably by means of a weld penetration 20 and/or by means of a reflection pattern 32. It should be noted that in the case of an (additional or alternative) caustic measurement, visibility of the laser beam 4 in the form of a weld penetration 20 or reflection pattern 32 is not required.

FIG. 4 shows a motor vehicle 35 with brake discs 23 according to FIG. 1 in a schematic plan view. The motor vehicle 35 has a longitudinal axis 36 and propulsion wheels 37,38 designed for propulsion. The left propulsion wheel 37 and the right propulsion wheel 38 are designed to transmit toque to the ground and are connected to the motor vehicle 35 via a wheel hub 39. The brake discs 23 are designed to decelerate the propulsion, i.e. to absorb the torque of the propulsion wheels 37,38. The brake discs 23 are firmly connected to the wheel hubs 39 and arranged between the propulsion wheels 37,38 and the wheel hub 39. Each brake disc 23 is designed to convert the kinetic energy into thermal energy. The finishing layer reduces abrasion of the brake discs 23 during deceleration and/or provides corrosion protection.

The workpiece proposed here and the associated reference mark can be used for high-precision application of a finishing layer to the workpiece.

### LIST OF REFERENCES

1 coating apparatus
2 workpiece
3 laser device
4 laser beam
5 laser focus
6 powder nozzle
7 powder focus
8 feed actuator unit
9 powder material
10 surface to be coated
11 measuring apparatus
12 predetermined point
13 adjusting device
14 control device
15 sacrificial surface
16 machine coordinate system
17 memory unit
18 actuator coordinates
19 processor
20 weld penetration
21 diameter
22 distance
23 brake disc
24 basic body
25 tool chuck
26 axis of rotation
27 rotary drive
28 coating unit
29 coating axis
30 horizontal positioner
31 vertical positioner
32 reflection pattern
33 first adjusting unit
34 second adjusting unit
35 motor vehicle
36 longitudinal axis
37 left propulsion wheel
38 right propulsion wheel
39 wheel hub

1-10. (canceled)

11. Apparatus for coating a workpiece, having at least the following components:
a laser device for generating a laser beam with a laser focus;
a powder nozzle; and
a feed actuator unit for feeding the laser device and the powder nozzle;
wherein the laser device is designed for thermally treating powder material supplied via the powder nozzle for coating a surface of a workpiece and/or thermally treating this surface,
wherein
the apparatus also has:
a measuring apparatus for detecting coordinates of a point on a surface to be coated; and
at least one adjusting device for adjusting the laser focus and the powder nozzle relative to one another.

12. Apparatus according to claim 11, wherein
the adjusting device for adjusting the laser focus and the powder nozzle relative to one another is movable purely by a control device using an actuator.

13. Alignment method for coating a workpiece, wherein the alignment method is carried out with an apparatus according to claim 11 and furthermore a control device is provided for the apparatus,
wherein the alignment method is carried out by the control device and comprises at least the following steps:
a. by means of the feed actuator unit, moving the laser device, to a predetermined point on a sacrificial surface and remaining there;
b. by means of the feed actuator unit, moving the powder nozzle, to the predetermined point on the sacrificial surface;
c. after step a. by means of the laser device, determining the position of the laser focus relative to the point on the sacrificial surface;
d. after step b. and c., displaying the relative position of the laser focus determined in step c. so that by means of the adjusting device the powder nozzle is adjustable relative to the displayed relative position of the laser focus and thus relative to the laser focus.

14. Alignment method according to claim 13, wherein
in a step e. after step c. and before step d., the laser focus is adjusted,
by comparing, in a sub-step e.1 for determining a deviation by means of the measuring apparatus, the coordinates of the predetermined point with the coordinates of the relative position of the laser focus determined in step c., and preferably displayed in step d., and
by adjusting by means of the feed actuator unit and/or by means of the adjusting device, in a sub-step e.2 according to the deviation established in sub-step e.1, the laser focus relative to a fixed machine coordinate system of the apparatus.

15. Alignment method according to claim 13, wherein the apparatus for coating furthermore comprises:
a memory unit for storing detected coordinates relative to actuator coordinates; and
at least one processor for executing memory operations and calculations with coordinates stored on the memory unit, wherein in a step e. after step c., the laser focus is adjusted by comparing, in a sub-step e.1 for determining a deviation by means of the measuring apparatus, the coordinates of the predetermined point with the coordinates of the relative position of the laser focus determined in step c., and preferably displayed in step d., and
by changing, in a sub-step e.3 according to the deviation determined in sub-step e.1, the coordinates stored for the predetermined point in the memory unit.

16. Alignment method according to claim 13, wherein
in step c., a weld penetration is produced in the sacrificial surface and in step d., the weld penetration is visible as an indication of the relative position of the laser focus.

17. Alignment method according to claim 13, wherein
in step c., a caustic measurement is carried out to determine the relative position of the laser focus,
wherein preferably in step d., the relative position of the laser focus is visible by means of an optical projection on the sacrificial surface.

18. Alignment method according to claim 16, wherein
by means of the measuring apparatus, a diameter of the weld penetration in the sacrificial surface is detected in a step f.,
wherein, depending on the diameter detected in step f. of the weld penetration by means of the feed actuator unit and/or the adjusting device, a distance between the laser device and the sacrificial surface is set in a step g.

19. Computer program, comprising
a computer program code, wherein the computer program code can be carried out on at least one computer in such a way that the at least one computer is caused to carry out the alignment method according to claim 13, wherein at least one unit of the computer:
is arranged in the coating apparatus;
is designed for communication with an edge device, on which preferably at least a part of the computer program code is provided; and/or
is designed for communication with a cloud, on which preferably at least a part of the computer program code is provided.

20. Computer program product, on which
a computer program code is stored, wherein the computer program code is executable on at least one computer in such a way that the at least one computer is caused to carry out the alignment method according to claim 13, wherein at least one unit of the computer:
is arranged in the coating apparatus;
is designed for communication with an edge device, on which preferably at least a part of the computer program code is provided; and/or
is designed for communication with a cloud, on which preferably at least a part of the computer program code is provided.
